(19) United States
(12) Patent Application Publication
(10) Pub. No.: US 2023/0262356 A1
(43) Pub. Date: Aug. 17, 2023

(54) IMAGING SYSTEM AND OPTICAL DEVICE INCLUDING SAME

(71) Applicant: Century Technology (Shenzhen) Corporation Limited, Shenzhen (CN)

(72) Inventors: JUN-PING QIN, Shenzhen (CN); YUAN-HSING CHEN, Shenzhen (CN)

(21) Appl. No.: 17/852,705

(22) Filed: Jun. 29, 2022

(30) Foreign Application Priority Data
Feb. 11, 2022 (CN) 202210128780.2

(51) Int. Cl. H04N 5/372; H04N 5/225

(52) U.S. Cl. CPC H04N 5/372; H04N 5/2256; H04N 5/2254

(57) ABSTRACT

An imaging system includes a light source and a CCD camera. The light source includes a white LED. The light source is configured to emit light toward a target object. The CCD camera is configured to receive light reflected by the target object and form images by reflected light. An optical device including the imaging system is also provided.

### FIELD

The subject matter herein generally relates to an imaging system and an optical device having the imaging system.

### BACKGROUND

A high-pressure mercury lamp is a traditional lighting source used in operating a charge coupled device (CCD) camera (also known as CCD image sensor). However, there are obvious fluctuations in the reflectivity of the light in relation to photoresists with different thicknesses. Therefore, when a photoresist layer with uneven thickness covers a surface of an object, the contrast of the image captured is low after the CCD camera actually focuses, which affects the imaging.

### BRIEF DESCRIPTION OF THE DRAWINGS

Implementations of the present technology will now be described, by way of embodiments only, with reference to the attached figures.

FIG. 1 is a structural view of an imaging system according to an embodiment of the present disclosure.

FIG. 2 is a diagram showing relative spectral power distribution of each light source of the imaging system in FIG. 1.

FIG. 3 is a diagram showing a relationship between the photoresist film thickness and surface reflectance of the target object under irradiation by a mercury lamp light source.

FIG. 4 is a diagram showing a relationship between the photoresist film thickness and surface reflectance of the target object under irradiation by a white LED light source.

FIG. 5 is a view of an imaging picture of a CCD camera in the prior art.

FIG. 6 is a view of an image taken by the CCD camera in the embodiment of FIG. 1.

FIG. 7 is a structural view of an optical device according to an embodiment of the present disclosure.

FIG. 8 is a structural view of an optical device according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

The present disclosure provides an imaging system and an optical device. The imaging system can be applied in semiconductor manufacturing, especially in production processes using photoresist. The optical device is equipment such as a lithography machine and an automatic optical detector. The performance of the imaging system and the optical device is good even with the uneven photoresist film thickness and the product quality is improved.

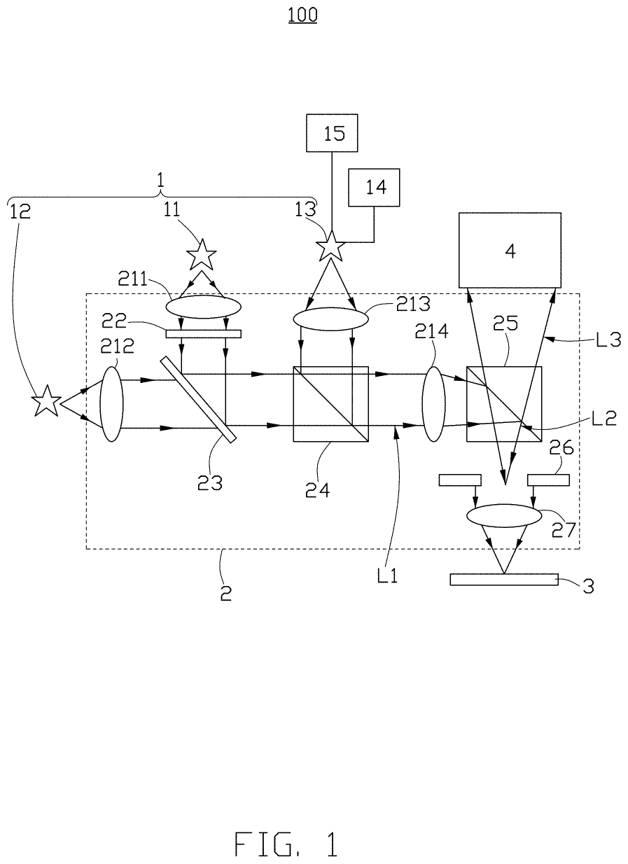

FIG. 1 illustrates an imaging system 100. The imaging system 100 includes a light source 1, a lens group 2, and a CCD camera 4. The lens group 2 is configured to guide light emitted from the light source 1 to a target object 3, and guide light reflected by the target object 3 to the CCD camera 4. The CCD camera 4 receives the light reflected by the target object 3 and images. The light source 1 includes a first light source 11, a second light source 12, and a third light source 13. The third light source 13 is a white LED light source. The light source 1 is not a mercury lamp.

In one embodiment, the lens group 2 includes a first collimating lens 211, a second collimating lens 212, a third collimating lens 213, a fourth collimating lens 214, a diffuser 22, a dichroic lens 23, a first prism 24, a second prism 25, an objective lens aperture 26, and an objective lens 27.

The first collimating lens 211 is on an optical path of the first light source 11 and configured to collimate light from the first light source 11. The second collimating lens 212 is on an optical path of the second light source 12 and configured to collimate light from the second light source 12. The third collimating lens 213 is on an optical path of the third light source 13 and configured to collimate light from the third light source 13.

The diffuser 22 is on the optical path of the first light source 11 and on a side of the first collimating lens 211 away from the first light source 11. The diffuser 22 expands the light from the first light source 11. The dichroic mirror 23 is on the optical path of both the first light source 11 and the second light source 12, on a side of the diffuser 22 away from the first collimating lens 211 and on a side of the second collimating lens 212 away from the second light source 12. The dichroic mirror 23 is configured for reflecting the light from the first light source 11 and transmitting the light from the second light source 12.

The first prism 24 is on the optical path of the first light source 11, the second light source 12 and the third light source 13, and on a side of the third collimating lens 213 away from the third light source 13 and a side of the dichroic mirror 23 away from the second collimating lens 212. The first prism 24 is configured to integrate light from the first light source 11, the second light source 12, and the third light source 13 into a single beam of light. The fourth collimating lens 214 is between the first prism 24 and the second prism 25 and configured to collimate the light from the first prism 24 to the second prism 25.

The second prism 25 is between the target object 3 and the CCD camera 4, and is configured to divide the incident light into two beams, one beam to the target object 3 and the other beam to the CCD camera 4. Alternatively, the two beams of light are arranged to reach the CCD camera 4 after reflection and/or refraction.

The objective lens aperture 26 and the objective lens 27 are between the second prism 25 and the target object 3, and the objective lens aperture 26 is on a side of the objective lens 27 adjacent to the second prism 25. The objective lens aperture 26 is configured to adjust the luminous flux of the passing light. The objective lens 27 is configured to converge the incident light to the position of the target object 3.

Specifically, the light emitted by the first light source 11 is collimated by the first collimating lens 211 and reaches the diffuser 22. The diffuser 22 expands the light of the first light source 11 and the expanded light reaches the dichroic mirror 23. The dichroic mirror 23 reflects the light from the diffuser 22 to the first prism 24.

The light emitted by the second light source 12 is collimated by the second collimating lens 212 and then reaches the dichroic mirror 23. The dichroic mirror 23 transmits the light from the second collimating lens 212 to the first prism 24.

The light emitted from the third light source 13 is collimated by the third collimating lens 213 and then reaches the first prism 24. After passing through the dichroic mirror 23, the light of the first light source 11 and the light of the second light source 12 are incident on the first prism 24 from same direction, which is different from the direction of the light of the third light source 13 incidents on the first prism 24.

The light of the first light source 11, the second light source 12 and the third light source 13 is combined into a beam of light after passing through the first prism 24, which is defined as a first combined light L1. The first combined light L1 is collimated by the fourth collimating lens 214 and then reaches the second prism 25. The second prism 25 divides the first combined light L1 into two beams, which are defined as a first split beam L2 and a second split beam L3. The first split beam L2 reaches the objective lens 27 after being adjusted by the objective lens aperture 26, and the second split beam L3 is from a direction different from a direction of the first split beam L2 toward the CCD camera 4. The first split beam L2 from the objective lens 27 reaches the target object 3, and the light reflected by the target object 3 is captured by the CCD camera 4 to form an image.

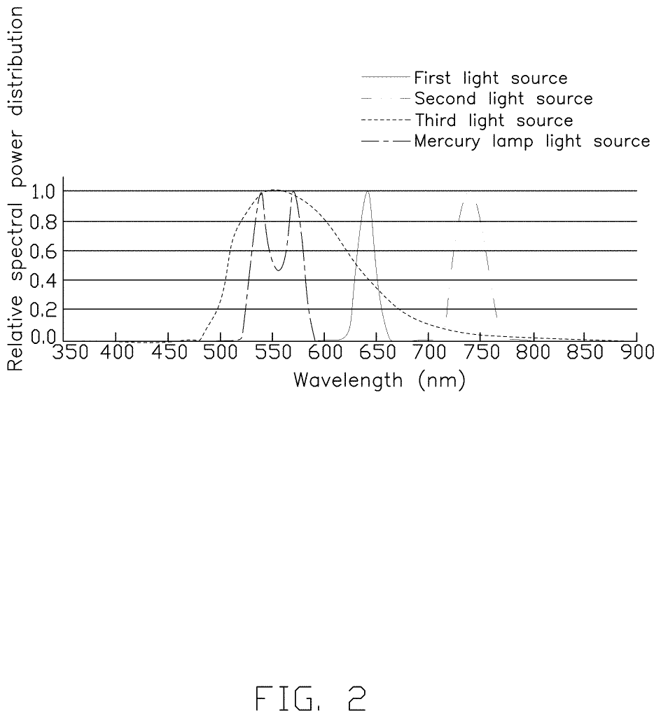

As shown in FIG. 2, in one embodiment, the first light source 11 is a red LED having a light-emitting wavelength band of 620 nm-660 nm. The second light source 12 is a red LED having a light-emitting band of 710 nm-770 nm. The third light source 13 is a white LED having a light-emitting band of 480 nm-730 nm. The first light source 11 supplements a light-emitting band with a spectral power which is lower than that of the third light source 13. The second light source 12 supplements a greater light-emitting band than that of the third light source 13. Compared with the light-emitting band of the mercury lamp light source, the light-emitting band of the third light source 13 has wider wavelength band, provides higher coverage, and more stable light source. Compared with traditional mercury lamp, LED light source has low energy consumption and long service life.

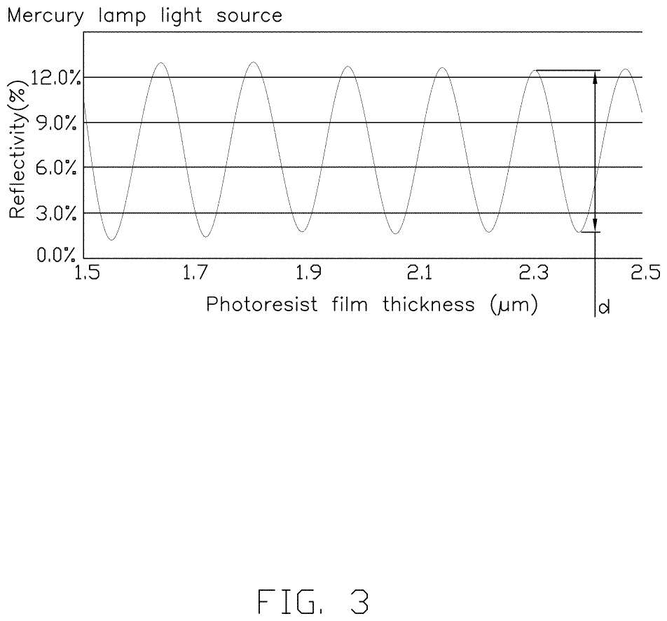

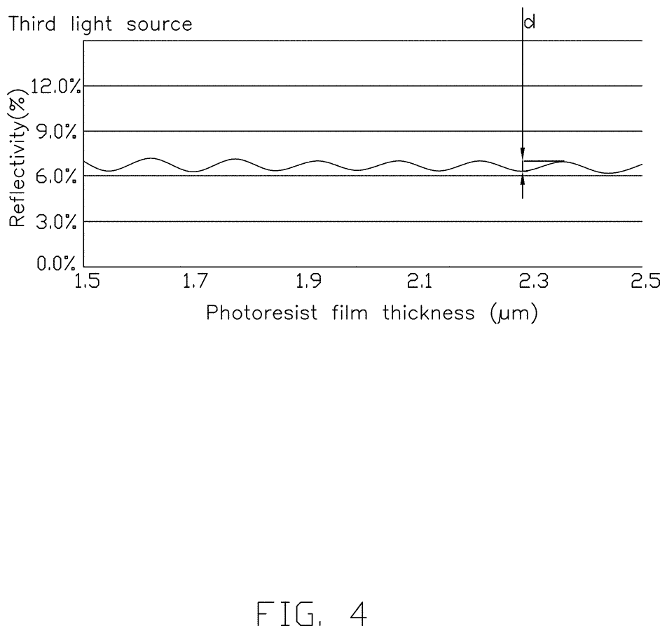

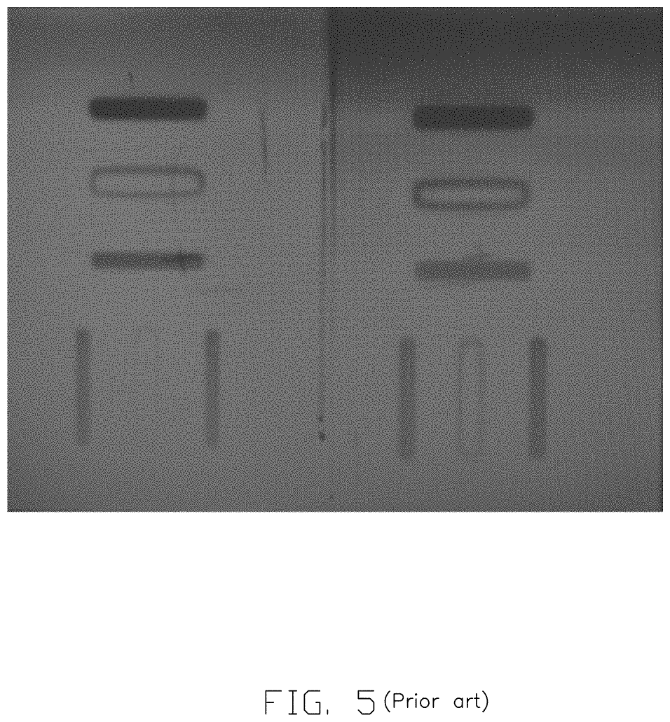

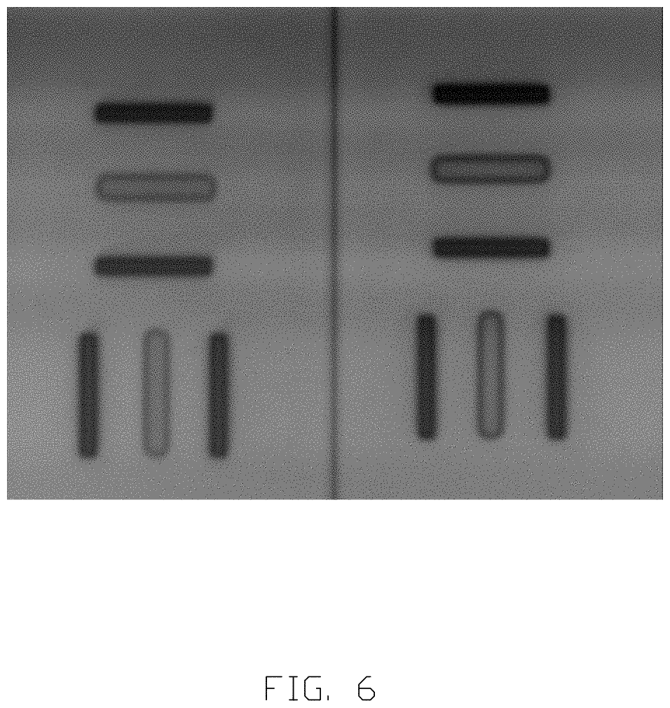

FIG. 3 to FIG. 6, for the production process using photoresist, show that the light reflectivity of photoresist affects imaging quality of CCD camera. FIG. 3 shows the relationship between the photoresist film thickness and the surface reflectance characteristics of the target object under irradiation by a mercury lamp light source. When the surface of the target object is covered by a photoresist film having a thickness in a range of 1.5 μm-2.5 μm, a difference D in reflectivity of the light of the mercury lamp light source in different areas of the photoresist with different thickness on the surface of the target object can be up to 10%, which significantly affects the contrast of the imaging picture. FIG. 4 shows the relationship between the photoresist film thickness and the surface reflectance characteristics of the target object under irradiation by the third light source in this embodiment. The third light source is a white LED light source. When the surface of the target object is covered by a photoresist film having a thickness in a range of 1.5 μm-2.5 μm, a difference D in reflectivity of the light of the white LED light source in different areas of the photoresist film with different thickness on the surface of the target object is within only 2%, so that contrast of the imaging picture is less affected by a change of photoresist thickness and provides a significant improvement. FIG. 5 is a view of an imaging picture of a CCD camera under illumination of a mixed light source of a first light source, a second light source, and a high-pressure mercury lamp in the prior art. A photoresist film with different thickness causes the contrast of the imaging picture to be inconsistent everywhere, some image edges are blurred, while some image edges are clear, both seriously affecting the imaging quality. FIG. 6 is a view of the imaging picture of the CCD camera under illumination of a mixed light source of the first light source, the second light source, and the third light source in this embodiment, images everywhere in the picture have clear edges, and the imaging quality is significantly improved.

In one embodiment, the imaging system 100 optionally includes a light intensity monitoring module 14 electrically connected to the third light source 13. The light intensity monitoring module 14 includes a photosensitive detector and a controller, which are configured to monitor the light intensity of the third light source 13 during operations and maintain stability of the light intensity. The photosensitive detector is configured to detect the light intensity of the third light source 13 and send the detection result to the controller. The controller adjusts the light intensity of the third light source 13 by controlling the driving voltage or driving current of the third light source 13, so as to maintain the stability of the light intensity.

In one embodiment, the imaging system 100 optionally includes a temperature monitoring module 15 electrically connected to the third light source 13. The temperature monitoring module 15 includes a thermal detector and a controller, which are configured to monitor the temperature of the third light source 13 during operation and protect the third light source 13 against overvoltage and overcurrent. The thermal detector is configured to detect the temperature of the third light source 13 and send the detection result to the controller. The controller adjusts the light intensity of the third light source 13 by controlling the driving voltage or driving current of the third light source 13, so as to prevent the temperature of the third light source 13 from being too high, so as to protect the third light source 13.

In the above embodiments, a number of light sources is three, it can be less or more in other examples. In addition, the light source includes a white LED and does not include a mercury lamp. In other examples, a number of light sources can be one, two, or more than three. For example, when the number of light sources is one only the white LED light source is included. For example, when the number of light sources is two, the white LED light source and the second light source are included. In other example, when the number of light sources is two the white LED light source and the first light source are included.

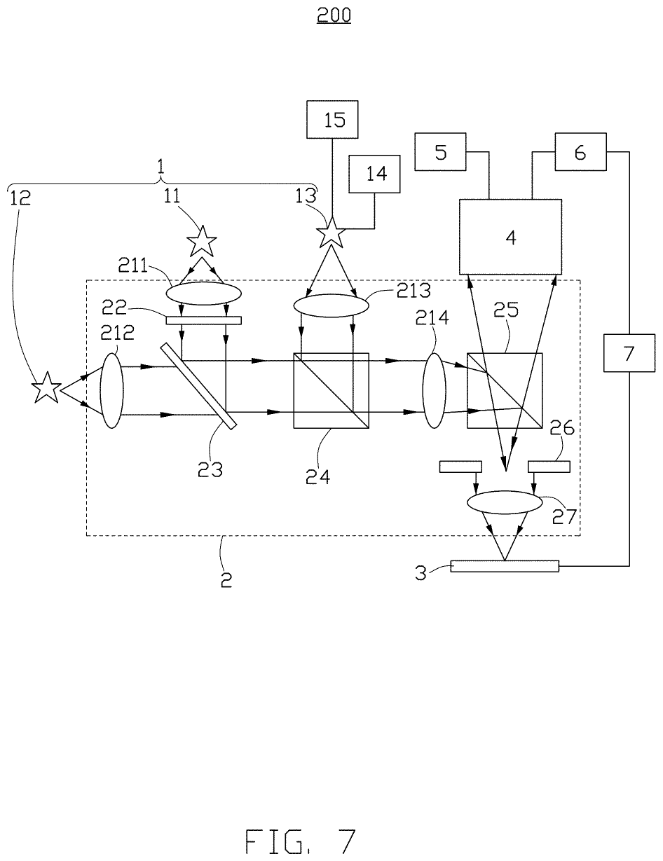

FIG. 7 illustrates an optical device 200 of a first embodiment. The optical device 200 includes the above described imaging system 100, a display 5, and a processor 6. Both the display 5 and the processor 6 are electrically connected to the CCD camera 4. The display 5 is configured to display the image acquired by the CCD camera 4, and the processor 6 is configured to process the image acquired by the CCD camera 4.

Optionally, the optical device 200 also includes a moving driver 7 electrically connected to both the processor 6 and the CCD camera 4. The moving driver 7 can move the target object 3 and change its position as the processor 6 dictates.

The optical device 200 can be applied in semiconductor industries to observe and modify the target object 3, such as an automatic optical detector. The optical device 200 particularly relates to the production process of using photoresist, which can cope with the uneven photoresist film thickness and improve the product quality. In other embodiments, the optical device 200 can also be applied to other detection machines to measure the critical dimensions (CD) after etching, critical dimensions after development, the total pitch (TP), or the test element group (TEG).

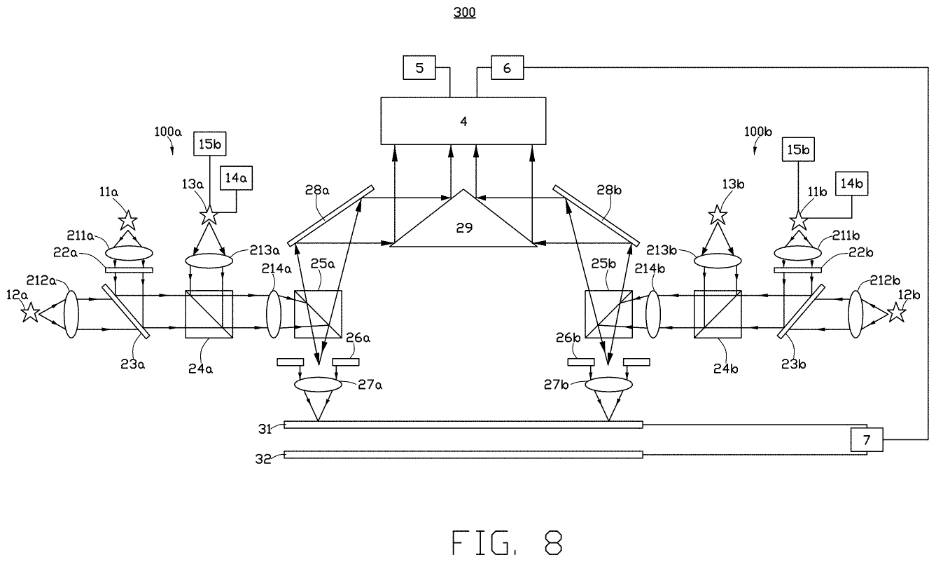

FIG. 8 illustrates an optical device 300 of a second embodiment. The optical device 200 includes an imaging system 100a, an imaging system 100b, a third prism 29, a display 5, a processor 6, and a moving driver 7. The imaging system 100a and the imaging system 100b are on opposite sides of the third prism 29. The imaging system 100a and the imaging system 100b are substantially symmetrical, and share a CCD camera 4. Both the display 5 and the processor 6 are electrically connected to the CCD camera 4, and the moving driver 7 is electrically connected to both the processor 6 and the CCD camera 4. The display 5 is configured to display the image obtained by the CCD camera 4, the processor 6 is configured to process the image obtained by the CCD camera 4, and the moving driver 7 can adjust position of the target object 3 according to the processor 6.

Compared with the imaging system 100, the imaging system 100a further includes a reflector 28a, and the imaging system 100b further includes a reflector 28b. Both the third prism 29 and the reflector 28a are between the CCD camera 4 and the second prism 25a, and the reflector 28a is configured to reflect the light from the second prism 25a to the third prism 29. Both the third prism 29 and the reflector 28b are between the CCD camera 4 and the second prism 25b, and the reflector 28b is configured to reflect the light from the second prism 25b to the third prism 29. The third prism 29 is a roof prism, which is configured to reflect the light from the reflector 28a and the reflector 28b to the CCD camera 4.

In one embodiment, the target object 3 includes a mask 31 and a glass substrate 32 for preparing a thin film transistor substrate for a liquid crystal display panel. The mask 31 and the glass substrate 32 are provided with alignment marks, and the alignment mark on the glass substrate 32 is covered by photoresist. The optical device 300 can realize alignment operation between the alignment marks on the mask 31 and the alignment marks on the glass substrate 32. Specifically, the CCD camera 4 takes image of the alignment mark on the mask 31 and the alignment mark on the glass substrate 32, and the processor 6 calculates a deviation in relative positions between the alignment mark on the mask 31 and the alignment mark on the glass substrate 32 from images of the alignment marks on both the mask 31 and the glass substrate 32 obtained by the CCD camera, the moving driver 7 finally changes the relative positions between the mask 31 and the glass substrate 32 according to the deviation calculated by the processor 6 to complete the alignment.

The optical device 300 can be applied in semiconductor industries, such as a lithography machine, for observation and alignment of the mask 31 and the glass substrate 32. By experiment, the optical device 300 used in the lithography machine is found to provide stable recognition accuracy of the alignment mark, the eigenvalue index for monitoring the recognition accuracy of the alignment mark is improved and stable, and the number of error reports due to poor recognition or misalignment of the alignment mark is almost zero.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An imaging system comprising:
a light source comprising a white LED, and configured to emit light toward a target object; and
a charge coupled device (CCD) camera configured to receive light reflected by the target object and form images by reflected light.

2. The imaging system of claim 1, wherein the light source further comprises a first light source having a light-emitting band of 620 nm-660 nm and a second light source having a light-emitting band of 710 nm-770 nm; and the white LED have a light-emitting band of 480 nm-730 nm.

3. The imaging system of claim 1, wherein when the target object is covered by a photoresist film having a thickness in a range of 1.5 μm-2.5 μm, a difference in reflectivity of light of the white LED in different areas of the photoresist film with the thickness between 1.5 μm and 2.5 μm is within 2%.

4. The imaging system of claim 1, further comprising a light intensity monitoring module configured for monitoring light intensity of the white LED.

5. The imaging system of claim 1, further comprising a temperature monitoring module configured for monitoring a temperature of the white LED.

6. The imaging system of claim 1, further comprising a lens group, wherein the lens group is configured to guide the light emitted from the light source to the target object, and guide the light reflected by the target object to the CCD camera.

7. The imaging system of claim 6, wherein the light source further comprises a first light source having a light-emitting band of 620 nm-660 nm and a second light source having a light-emitting band of 710 nm-770 nm; and
the lens group comprises a first collimating lens, a second collimating lens, a third collimating lens, a fourth collimating lens, a first prism, a second prism, and an objective lens.

8. The imaging system of claim 7, wherein the first collimating lens is located at a light emitting position of the first light source; the second collimating lens is located at a light emitting position of the second light source; and the third collimating lens is located at a light emitting position of the white LED; the first prism is located at a light output position of the third collimating lens; the fourth collimating lens is located at a light output position of the first prism; the second prism is located at a light output position of the fourth collimating lens; and the objective lens is located between the second prism and the target object.

9. The imaging system of claim 8, wherein the lens group further comprises a diffuser on an optical path of the first light source and on a side of the first collimating lens away from the first light source; and
the lens group further comprises a dichroic mirror on a side of the diffuser away from the first collimating lens and on a side of the second collimating lens away from the second light source.

10. The imaging system of claim 9, wherein the first prism is configured to combine light of both the first light source and the second light source after passing through the dichroic mirror and light of the white LED after collimated by the third collimating lens into a first combined light; and
the second prism is configured to divide the first combined light into a first split beam toward the target object and a second split beam toward the CCD camera.

11. An optical device comprising:
an imaging system comprising:
a light source comprising a white LED and configured to emit light toward a target object;
a charge coupled device (CCD) camera, the CCD camera configured to receive light reflected by the target object and form images by reflected light;
a display, the display electrically connected to the CCD camera and configured to display images obtained by the CCD camera; and
a processer, the processer electrically connected to the CCD camera and configured to calculate images obtained by the CCD camera.

12. The optical device of claim 11, further comprising a moving driver, wherein the moving driver is configured to change a position of the target object according to operation results of the processor.

13. The optical device of claim 11, wherein the light source further comprises a first light source having a light-emitting band of 620 nm-660 nm and a second light source having a light-emitting band of 710 nm-770 nm; and the white LED have a light-emitting band of 480 nm-730 nm.

14. The optical device of claim 11, wherein when the target object is covered by a photoresist film having a thickness in a range of 1.5 μm-2.5 μm, a difference in reflectivity of light of the white LED in different areas of the photoresist film with the thickness between 1.5 μm and 2.5 μm is within 2%.

15. The optical device of claim 11, wherein the imaging system further comprises a light intensity monitoring module configured for monitoring light intensity of the white LED.

16. The optical device of claim 11, wherein the imaging system further comprises a temperature monitoring module configured for monitoring a temperature of the white LED.

17. The optical device of claim 11, wherein the imaging system further comprises a lens group, wherein the lens group is configured to guide the light emitted from the light source to the target object, and guide the light reflected by the target object to the CCD camera.

18. The optical device of claim 17, wherein the light source further comprises a first light source having a light-emitting band of 620 nm-660 nm and a second light source having a light-emitting band of 710 nm-770 nm; and
the lens group comprises a first collimating lens, a second collimating lens, a third collimating lens, a fourth collimating lens, a first prism, a second prism and an objective lens.

19. The optical device of claim 18, wherein the first collimating lens is located at a light emitting position of the first light source; the second collimating lens is located at a light emitting position of the second light source; and the third collimating lens is located at a light emitting position of the white LED; the first prism is located at a light output position of the third collimating lens; the fourth collimating lens is located at a light output position of the first prism; the second prism is located at a light output position of the fourth collimating lens; and the objective lens is located between the second prism and the target object.

20. The imaging system of claim 19, wherein the lens group further comprises a diffuser on an optical path of the first light source and on a side of the first collimating lens away from the first light source;
the lens group further comprises a dichroic mirror on a side of the diffuser away from the first collimating lens and on a side of the second collimating lens away from the second light source;
the first prism is configured to combine light of both the first light source and the second light source after passing through the dichroic mirror and light of the white LED after collimated by the third collimating lens into a first combined light; and
the second prism is configured to divide the first combined light into a first split beam toward the target object and a second split beam toward the CCD camera.
